(19) United States
(12) Patent Application Publication
(10) Pub. No.: US 2013/0086578 A1
(43) Pub. Date: Apr. 4, 2013

(54) VIRTUAL IMAGE CONSTRUCTION

(71) Applicants: Tamar EILAM, New York, NY (US); Michael H. KALANTAR, Chapel Hill, NC (US); Fabio A. OLIVEIRA, White Plains, NY (US)

(72) Inventors: Tamar EILAM, New York, NY (US); Michael H. KALANTAR, Chapel Hill, NC (US); Fabio A. OLIVEIRA, White Plains, NY (US)

(73) Assignee: INTERNATIONAL BUSINESS MACHINES CORPORATION, Armonk, NY (US)

(21) Appl. No.: 13/248,624

(22) Filed: Sep. 29, 2011

(51) Int. Cl. G06F 9/455

(52) U.S. Cl. 718/1

(57) ABSTRACT

A requirement graph defined by a user is analyzed. A set of user-defined requirements is identified, based on the analyzing, for constructing a virtual image. A set of models is analyzed based on the set of user-defined requirements that have been identified. Each semantic in the set of models represents at least one capability and one requirement of a virtual image building block in a plurality of virtual image building blocks. A set of virtual image construction solutions is generated based on analyzing the set of models. Each virtual image construction solution includes at least one set of virtual image building blocks from the plurality of virtual image building blocks. The at least one set of virtual image building blocks satisfies the set of user-defined requirements and requirements of each virtual image building block within the at least one set of virtual image building blocks.

### BACKGROUND

The present invention generally relates to computing system virtualization technologies, and more particularly relates to using semantically rich building blocks to construct virtual images.

Virtualization, and specifically, virtual image technology such as VMware® is a pervasive trend that is perceived as holding a tremendous promise to reduce Information Technology (IT) management cost. This perception is based on the simplicity of capturing and making persistent complete software stacks, including multiple software components and configuration. The technology enables a small number of IT experts to codify a number of IT best practice patterns in a relatively small set of virtual images to be re-used by the entire organization. The reduction in cost stems from the reduction in the number of software variations to be maintained. IT infrastructure standardization, namely, the reduction of IT infrastructure software variability (such as software product types, versions, and configuration in and across servers), is a crucial element in the reduction of IT management cost, and in many cases virtualization is perceived as an enabling technology.

### BRIEF SUMMARY

In one embodiment, a method for identifying building blocks for creating a virtual image is disclosed. The method comprises analyzing a requirement graph defined by a user. A set of user-defined requirements is identified, based on the analyzing, for constructing a virtual image. A set of models is analyzed based on the set of user-defined requirements that have been identified. Each model in the set of semantic models represents at least one capability and one requirement of a virtual image building block in a plurality of virtual image building blocks. A set of virtual image construction solutions is generated based on analyzing the set of models. Each virtual image construction solution comprises at least one set of virtual image building blocks from the plurality of virtual image building blocks. The at least one set of virtual image building blocks satisfies the set of user-defined requirements and requirements of each virtual image building block within the at least one set of virtual image building blocks.

In another embodiment, a system for identifying building blocks for creating a virtual image is disclosed. The system comprises a memory and a processor communicatively coupled with the memory. A building block searching module is communicatively coupled to the memory and the processor. The building block searching module is configured to perform a method comprising analyzing a requirement graph defined by a user. A set of user-defined requirements is identified, based on the analyzing, for constructing a virtual image. A set of models is analyzed based on the set of user-defined requirements that have been identified. Each model in the set of semantic models represents at least one capability and one requirement of a virtual image building block in a plurality of virtual image building blocks. A set of virtual image construction solutions is generated based on analyzing the set of models. Each virtual image construction solution comprises at least one set of virtual image building blocks from the plurality of virtual image building blocks. The at least one set of virtual image building blocks satisfies the set of user-defined requirements and requirements of each virtual image building block within the at least one set of virtual image building blocks.

In yet another embodiment, a computer program product for identifying building blocks for creating a virtual image is disclosed. The computer program product comprises a storage medium readable by a processing circuit and storing instructions for execution by the processing circuit for performing a method. The method comprises analyzing a requirement graph defined by a user. A set of user-defined requirements is identified, based on the analyzing, for constructing a virtual image. A set of models is analyzed based on the set of user-defined requirements that have been identified. Each model in the set of semantic models represents at least one capability and one requirement of a virtual image building block in a plurality of virtual image building blocks. A set of virtual image construction solutions is generated based on analyzing the set of models. Each virtual image construction solution comprises at least one set of virtual image building blocks from the plurality of virtual image building blocks. The at least one set of virtual image building blocks satisfies the set of user-defined requirements and requirements of each virtual image building block within the at least one set of virtual image building blocks.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 is block diagram illustrating the lifecycle of virtual images according to one embodiment of the present invention;

FIG. 3 is a block diagram illustrating a detailed view of a virtual image construction tool according to one embodiment of the present invention;

FIG. 4 illustrates one example of semantic models for software bundles and virtual images according to one embodiment of the present invention;

FIG. 5 illustrates one example of a requirement graph according to one embodiment of the present invention;

FIG. 6 shows an algorithm for performing a greedily guided search for virtual image building blocks according to one embodiment of the present invention;

FIG. 7 is an operational flow diagram illustrating one example of a virtual image building block search process according to one embodiment of the present invention;

FIG. 8 is an operational flow diagram illustrating one example of a greedy-based search process for identifying virtual image building blocks according to one embodiment of the present invention;

FIG. 9 is an operational flow diagram illustrating one example of an integer programming based search process for identifying virtual image building blocks according to one embodiment of the present invention;

FIG. 10 illustrates one example of a cloud computing node according to one embodiment of the present invention;

FIG. 11 illustrates one example of a cloud computing environment according to one example of the present invention; and

FIG. 12 illustrates abstraction model layers according to one example of the present invention.

### DETAILED DESCRIPTION

As discussed above, IT infrastructure standardization is becoming increasingly important to many large enterprises. Virtualization is one technology that can be used to achieve this standardization. However, there are multiple roadblocks in reaching this desired state. First, constructing a virtual image capturing a multi-component software stack is at least as difficult as the traditional software installation and configuration problem. Second, it is hard to effectively re-use images due to many factors, including multiplicity of cloud and virtualization platforms, difficulty to find images based on requirements in a large, non-descriptive repository or cloud, and difficulty customizing an image network setting and other user preferences.

Moreover, enterprises adopting virtualization and automation without a clear methodology for standardization are suffering from an adverse effect on cost. This phenomenon is referred to as image sprawl (See, for example, Reimer et al, “Opening black boxes: using semantic information to combat virtual machine image sprawl”, in VEE, pages 111-120. ACM, 2008, which is hereby incorporated by reference in its entirety). In this situation, the number of virtual images grows exponentially with no reuse, resulting in an increase, rather than reduction, in IT maintenance cost. The root cause of this unfortunate phenomenon is that the cost is linked to the number of different components to be maintained, virtual or physical. With no commonality between the virtual images constructed (i.e., lack of standardization), the maintenance cost simply grows with the number of virtual images; this growth in cost is more significant than the savings due to hardware consolidation.

Operating Environment

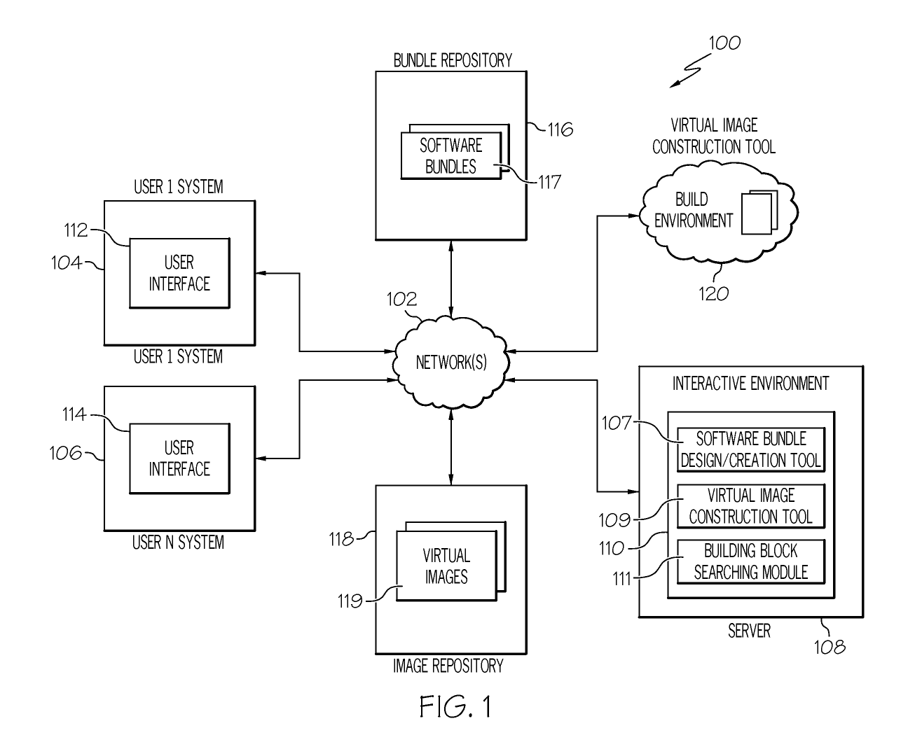

Therefore, one or more embodiments provide an operating environment, as shown in FIG. 1, for the construction of virtual images using virtualization technologies based on a set of standardized building blocks. These buildings blocks can be software bundles or existing virtual images that are associated with semantically-rich metadata. The metadata expresses what software products are provided, what software needs to be installed and how. Based on this standardized set of building blocks, image builders can define their requirements in terms of the desired virtual image as a requirement graph. A set of algorithms is provided to construct an optimized “bill of materials” that satisfies all the user requirements. Based on the characteristics of results, the user can then select the most suitable virtual image for construction.

The operating environment of FIG. 1 can be a cloud computing environment or a non-cloud computing environment. FIG. 1 shows one or more networks 102 that, in one embodiment, can include wide area networks, local area networks, wireless networks, and/or the like. In one embodiment, the environment 100 includes a plurality of information processing systems 104, 106, 108 that are communicatively coupled to the network(s) 102. The information processing systems 104, 106, 108 include one or more user systems 104, 106 and one or more servers 108. The user systems 104, 106 can include, for example, information processing systems such as desktop computers, laptop computers, wireless devices such as mobile phones, personal digital assistants, and the like.

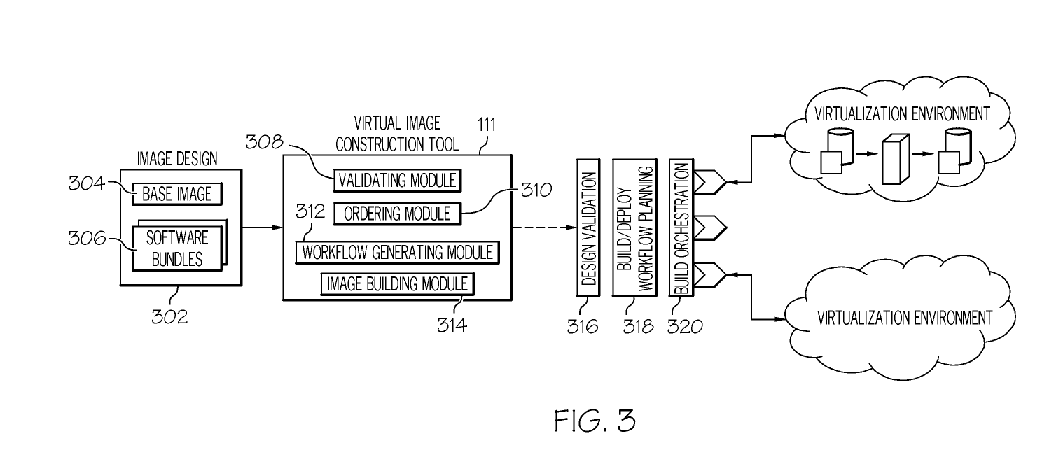

The server system 108 includes, for example, an interactive environment 110 for designing and creating composable software bundles asset and virtual image assets. Users of the user systems 104, 106 interact with the interactive environment 110 via a user interface 112, 114 or programmatically via an API. The interactive environment 110, in one embodiment, comprises a software bundle design/creation tool 107, a virtual image construction tool 109, and a building block searching module 111. The bundle design/creation tool 107 is used to define and publish composable software bundle assets. The virtual image construction tool 109 is used to define and publish virtual image assets, and is described in more detail with respect to FIG. 3. The building block searching module 111, in one embodiment, searches for building blocks (software bundles and virtual images) within repositories 116, 118 that satisfy user requirements with as few software products as possible so as to minimize the number of components that are part of the image. It should be noted that other searching methods can be performed that identify building blocks based on other characteristics as well. These identified building blocks can then be presented to the user via the user interface 112, 114 as a set of virtual image construction solutions. The user is then able to select these identified building blocks to create an image design that is passed to the virtual image construction tool 109 as an input. The building block searching module 111 is discussed in greater detail below.

Each of these tools 107, 109, 111 can include at least one of an application(s), a website, a web application, a mashup, or the like. The interactive environment 110 allows composable software bundle assets to be created and managed and also allows new virtual image assets (image assets) to be created from these bundle assets. As part of this process execution packages are generated and executed to extend an image with a number of software bundles.

A composable software bundle (also referred to herein as a “bundle”, “software bundle”, “software bundle asset”, “bundle asset”, or other similar variations, which are used interchangeably) is a cloud independent description of software that captures those aspects needed to install and configure it in a virtual machine. This description allows the bundle to be used to support image asset construction for multiple target cloud platforms. The metadata for each bundle describes one or more of: (1) the software's requirements and capabilities to ensure valid composition; (2) the install steps that need to be executed and their parameters as part of a virtual image build life-cycle phase; (3) the deploy time configuration steps that need to be executed and their parameters as part of a virtual image deploy life-cycle phase (4) the deploy time configurations that can be made with external software via virtual port definitions; and (5) the capture time cleanup steps that need to be executed and their parameters as part of a virtual image capture life-cycle phase. The metadata can comprise references to specific artifacts: scripts, binaries, response files, etc. These can be local references (the artifacts are contained in the bundle) or remote references (to a remote repository). It should be noted that other virtual image life-cycle phases such as, but not limited to, a start phase can be supported as well.

With respect to virtual image assets (also referred to herein as a “image”, “virtual image”, “image asset”, or other similar variations, which are used interchangeably), the interactive environment 110, uses a platform independent image description model that can be used to describe an image asset's: (1) contents and capabilities; (2) hardware requirements including hypervisor requirements; (3) deployment time configuration steps that are to be executed and their parameters; and (4) capture time cleanup steps that must be executed and their parameters. As with composable software bundles, an image asset comprises both the image description and any required disk images, scripts, binaries, etc., either directly or by reference, needed to deploy the image asset.

FIG. 1 also shows that a bundle repository 116 and an image asset repository 118 are communicatively coupled to the server 108 via the network(s) 102. These repositories 116, 118 store the reusable bundle and image assets 117, 119 respectively. It should be noted that even though FIG. 1 shows the bundle repository 116 and an image asset repository 118 residing outside of the server 108 these repositories 116, 118 can reside within the server 108 and/or in the same location as well. It should be noted that the image asset bundle repository 118 can be the same or different than the bundle repository 116.

A build environment 120 is also communicatively coupled to the network(s) 102 that provides the interactive environment 110 with virtual machines with which it can build virtual image asset assets. The build environment 120, in one embodiment, can also comprise the image asset repository 118. It should be noted that there can be multiple bundle and image asset repositories 116, 118 and multiple build environments 120.

As will be shown in greater detail below, the operating environment 100 allows one or more embodiments to leverage virtualization to achieve standardization, and thus, a true reduction in IT management cost. Experts may construct software bundles codifying best practice software installation and configurations. Non-expert practitioners are then able to use the set of software bundles to easily compose multiple combinations of images to meet their particular requirements. All the artifacts (bundles and images) are self-describing through a formal language and contain built-in customization points. Thus, the artifacts are easy to share, re-use, and compose.

Furthermore, various embodiments of the present invention allow non-expert practitioners to not only verify compatibility between two building blocks (i.e., image-bundle compatibility), but also to select an optimal bill of materials (bundle-image set) that meets a set of requirements, balancing quality, cost, time, and size. These embodiments provide two different sets of algorithms (greedy and integer programming based) that identify the best bill of materials (in the form of a non-empty set comprising a virtual image and a set of bundles) for given input requirements.

Various embodiments of the present invention are advantageous over conventional systems because one or more embodiments (1) focus on both software bundles and images as artifacts to be shared and re-used; and (2) use a formal, typed-graph like language to describe (parameterized and customizable) structure including a complex set of capabilities, requirements, and automation. The focus on bundles as a main artifact allows an effective collaboration and better re-usability in two aspects: (1) parallelization of the work by IT experts as they codify their knowledge of different software products independently in different bundles; and (2) better re-usability, as the same collection of bundles can be used to create virtual images in different platforms and clouds. The use of formal structure allows better sharing of images and bundles and enables sophisticated algorithms to produce substantially optimal results. In particular, automation of image composition is based on a rigorous design phase, where compatibility of building blocks is validated and best bill of materials is identified. Images inherit their formal structure from the bundles used for their construction, thus images can be further re-used as a basis to add new bundles to create new images. This is in contrast with existing technologies that require images to be built from scratch every time. Another advantage is that various embodiments of the present invention can be implemented within existing systems such as the IBM® Image Construction and Composition Tool and the system discussed in the commonly owned U.S. patent application entitled “Designing and Building Images Using Semantically Rich Composable Software Image Bundles”, application Ser. No. 13/036,588, which is hereby incorporated by reference in its entirety.

Image Building with Software Bundles

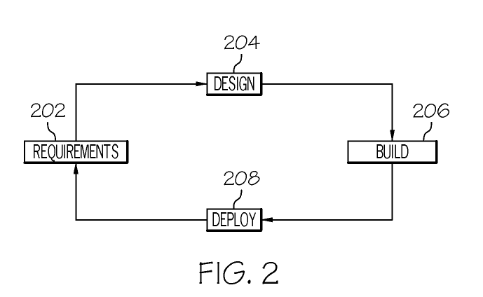

A few examples of lifecycle stages for virtual images are depicted in FIG. 2. It should be noted that virtual images can be associated with other lifecycle stages as well First, there is an initial requirements gathering phase 202 to identify the image contents. Once the requirements are gathered, there is an image design phase 204 to select a specific target virtualization environment (i.e., cloud) and the operating system and software that will be used. Furthermore, deployment time configuration options are identified. The image design is implemented in the build phase 206. The resulting image can then be deployed in the deploy phase 208. As a result of experience with the image, new requirements are gathered for the next iteration of the image development.

Various embodiments of the present invention are directed to the image design and build phases 204, 206 of this lifecycle, where formal models of images and software bundles are used to automate the image build phase. These models can be used to automate the image design phase as well. In one embodiment, a software bundle is a reusable asset created by a software expert and can be used to construct virtual images in any virtualization environment. A software bundle optionally comprises software and one or more image build operations, i.e., scripts to install the software. In addition, a software bundle can also comprises contain zero or more image deploy operations used to configure the software at image deployment. More importantly, a software bundle includes a formal description (which is discussed in greater detail below) of the software included within the bundle, the bundle's requirements for installation and configuration, and a description of the image build and image deploy operations. The formal model used to describe software bundles is image and virtualization environment independent. A more detailed discussion on software bundles, their design/creation, and the tool(s) for designing/creating software bundles is given in the commonly owned U.S. patent application entitled “Semantically Rich Composable Software Image Bundles”, Ser. No. 12/865,461, which is hereby incorporated by reference in its entirety.

Using software bundles, an image builder is responsible for image design. The image builder interacts with the interactive environment 110, via the user interface 112, to select a base image 119 from the image repository 118 that is to be extended. The image builder also selects, via the user interface 112, a set of software bundles 117 from the bundle repository 116 that are to be added to the image 119. The virtual image construction tool 109 can then be used to validate and implement the design using the image and bundle models.

FIG. 3 shows a more detailed view of the virtual image construction tool 109. The virtual image construction tool 109 takes as input an image design 302 comprising a base image 304 and a set of software bundles 306. The virtual image construction tool 109 comprises a validating module 308, an ordering module 310, a workflow generating module 312, and an imaging building module 314. In a first stage 316, the validating module 308 validates the requirements of each software bundle in the set of bundles 306 against the capabilities of the image 304 and the other software bundles in the set of bundles 306 ensuring the design is valid. In a second stage 318, the ordering module 310 orders the image build and deploy operations of the software bundles in the set of bundles 306 based on requirement dependencies, operational dependencies, and parameter relationships (See, for example, T. Eilam et al., “Pattern-based composite application deployment”, In IM, 2011, which is hereby incorporated by reference in its entirety). The workflow generating module 312 generates a workflow (e.g., a script) that executes the image build operations and configures the image deploy operations to run in the determined order. In a third stage 320, the image building module 314 builds the image using a general mechanism that deploys the base image, configures and executes the build workflow, and captures the resulting image. This stage can utilize plug-ins for cloud interaction and to generate any virtualization-specific artifacts.

The virtual image construction tool 109 increases reuse by using an intermediate asset, the software bundle. Bundles can be developed by software experts without reference to any particular virtualization environment and can be used by less skilled image builders to build images in multiple virtualization environments. The formal models for the building blocks (base image and bundles) are composed into a model for the image design that can be interpreted by tools to automate image construction in different environments. The image models further increase manageability by enabling search and validation capabilities.

Building Block Models

As can be seen above, images are constructed by selecting a base image and extending it with one or more software bundles. One or more embodiments rely on these building blocks being formally described by models that can be composed and validated. In one embodiment, these models are semantic models and automation models. Semantic modules are used for validating image design. Automation models are used for image build automation and deployment.

Semantic models can be expressed using typed attributed graphs labeled over a pre-defined abstract data type set. Let L_{V} and L_{E} be respectively the set of node label and edge label alphabets. Typed attributed graphs are further described in H. Ehrig et al., “Fundamental Theory for Typed Attributed Graphs and Graph Transformation based on Adhesive HLR Categories”, Fundam. Inf., 74:31-61, October 2006, which is hereby incorporated by reference in its entirety. The attributed graph of one embodiment is given by the tuple (V, E, l_{V}) where E⊂V×L_{E}×V and lᵥ:V→L_{V} is the node labeling function.

Some of the core node and edge data types (the sets L_{V} and L_{E}) of the modeling language used by one or more embodiments will now be defined. It should be noted that a more detailed discussion of this modeling language is given in W. Arnold et al., “Pattern based SOA deployment”, in ICSOC, volume 4749 of LNCS, Springer, 2007, which is hereby incorporated by reference in its entirety. All node types L_{V} inherit from a base type termed “unit” that includes the following attributes: (1) conceptual of type Boolean, denoting if a unit is abstract and needs to be refined; and (2) the attributes initstate and goalstate that are enumerations over the set of lifecycle states that a resource can be in.

Relationship types L_{E} include but are not limited to: hosting, identifying the runtime container of a component, propagation, identifying dependencies between values of configuration attributes, anti-collocation, identifying that two units cannot be hosted in a common runtime container, and realization, identifying a source conceptual unit (conceptual=true) and its target concrete (conceptual=false) realizing unit.

Concrete units describe the capabilities of the building blocks, while conceptual units describe requirements. In addition, a conceptual unit may be associated with zero or more constraints on the values of its attributes. When a realization relationship is established between a conceptual unit and a target concrete unit, the concrete unit realizes the conceptual unit, and the requirement expressed by the conceptual unit is satisfied by the concrete unit. Formally, the semantics of realization is defined as follows. For a concrete target unit U₂ to be a valid local realization of a conceptual source unit U₁, U₂'s type needs to be a (non-strict) sub-type of U₁. In addition, values of attributes need to “agree”, .i.e., they are either the same or satisfy all associated constraints. The realization concept is generalized to include multi-unit models. Specifically, for a pattern P containing only conceptual units and a model D, a one-to-one realization function R:P_{V}→D_{V}, where P_{V} and D_{V} are the respective sets of nodes in P and D, is termed a valid realization of P in D if for every pεP_{V}, R(p)εD_{V} is a valid local realization of p (as defined above), and R defines a subgraph isomorphism for P and D.

Automation models are expressed using a set of automation signatures, one for each operation, as discussed in T. Eliam et al. “Pattern-based composite application deployment”. The operation type (in L_{V}; extends the unit type) is further extended to include a _{runAt} attribute identifying the image lifecycle phase to which the operation applies. Other attributes on the operation type identify the command to be executed, its parameters and context, and any dependencies on other operations. These details are used to automatically generate workflows for the build and deploy lifecycle phases of a virtual image. See T. Eliam et al. “Pattern-based composite application deployment”.

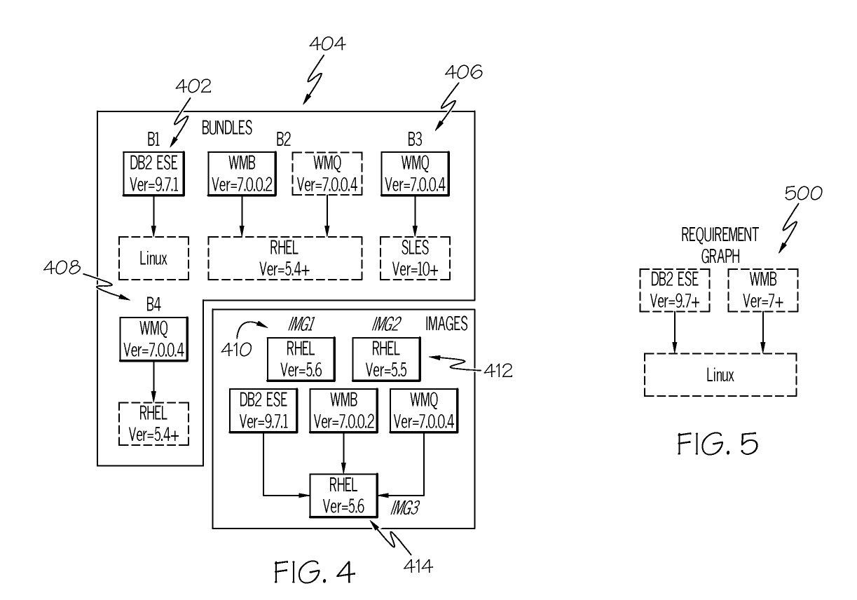

The semantic model of a virtual image describes the desired/target state of a virtual machine created from the image. The semantic model comprises an instance of an operating system type with attributes to identify the type, distribution, and version of the operating system. For example, FIG. 4 shows examples of semantic models of seven building blocks 402 to 414 (bundles and images). The three image models 410, 412, 414 depicted in FIG. 4 include the Red Hat Enterprise Linux (RHEL) operating system. Optionally, the semantic model of an image can include a single instance of the server type identifying the physical server architecture. Further, the model can include zero or more instances of the softwareinstall type representing the software installed on the virtual machine. For instance, Img3's model in FIG. 4 depicts an image comprising three software products installed on RHEL 5.6: DB2 version 9.7.1, WebSphere Message Broker (WMB) 7.0.0.2, and WebSphere MQ (WMQ) 7.0.0.4. All units of the model, in one embodiment, need to be concrete (conceptual=false), as represented by solid rectangles, and have a lifecycle state (initstate=installed, desiredstate=installed) indicating that they are present in any virtual machine created from the image.

The automation model of a virtual image comprises automation signatures for all deploy-time configuration operations, executed to customize the image. The model can also include automation signatures for build operations. In this case, operations are executed at deploy time prior to the deploy operations.

The semantic model of a software bundle describes the desired/target state of software after it has been installed and configured on a virtual machine. A software bundle includes one conceptual instance of the operatingsystem type, representing the operating system required by the bundle, and zero or more concrete instances of the softwareinstall type, one for each software product that will be installed by the bundle. A software bundle can further include zero or more conceptual instances of the softwareinstall type indicating required software products that need to be present before the bundle operations can be used. Conceptual instances can be associated with constraints on the values of the attributes that need to hold true in any realization of the conceptual unit. In FIG. 4, conceptual units are represented by dashed rectangles. For example, consider bundle B2's model (as shown in the group of bundles 404 in FIG. 2), representing that bundle B2: requires the RHEL operating system version 5.4 or higher (constraint); requires WMQ version 7.0.0.4; and provides WMB version 7.0.0.2. Both concrete and conceptual units have a lifecycle state <initstate=unknown, desiredstate=installed>. The automation model for a software bundle comprises automation signatures for all operations that apply to the software bundle. This includes the image build operations to install the software and virtual image deploy life-cycle operations to configure the software when a virtual machine is created.

A software bundle can be composed with an image if the requirements of the bundle can be satisfied by the image or any bundles already composed with the image. Formally, suppose I={b₁, b₂, . . . , bₙ} is a composition of a base image (b₁) and a set of software bundles ({b₂, b₃, . . . , bₙ}). Software bundle bₙ₊₁ can be composed with I if (1) the pattern created by the subset of conceptual units in bₙ₊₁ can be realized by the set of concrete units in I, and (2) any dependencies expressed in the automation model do not introduce cycles.

Image Design as Search

Thus far, the problem of automating the virtual image build life-cycle phase has been discussed. The semantically rich, typed graph models discussed above enable various embodiments to provide a novel approach to automating and optimizing virtual image design. In this context, one or more embodiments treat image design as a search problem and utilize the building block searching module 111 to find an optimized set of building blocks that, when put together, comprise an image that best satisfies the requirements of the user. This optimized set of building blocks is presented to the user via the user interface 112, 114. The user is able to select one or more of these optimized building blocks to create an image design 302 that is passed to the virtual image construction tool 109, as discussed above.

In one embodiment, the building block searching module 111 takes at least two inputs. The first input is a repository 116, 118 of building blocks 117, 119 (software bundles and images). The second input is a requirement graph, which is a typed graph represented in the same formal language that is used to model software bundles and images. The user can create a requirement graph using the interactive environment 110 via the user interface 112, 114. This graph captures the characteristics that the user wants in an image, such as operating system features (e.g., type, distribution, and version constraints) and required software products and corresponding version constraints. These requirements are expressed using conceptual units as before. For instance, FIG. 5 shows a requirement graph 500 expressing that the user is looking for an image containing DB2 version 9.7 or higher and WMB version 7 or higher, both products being hosted on Linux (any distribution and version).

The output of the search performed by the building block searching module 111 is a list of possible solutions S=[I₁, I₂, . . . , Iₙ] such that each solution Iᵢ is a set of building blocks that contains exactly one base image and zero or more software bundles. Each solution IᵢεS is complete, i.e., it leaves no requirement unsatisfied; in other words, not only does Iᵢ satisfy all requirements of the requirement graph, but it also satisfies all requirements that may have been added by its building blocks. Note that a solution with no software bundles corresponds to an image that already exists in the repository, whereas a solution containing one or more software bundles represents a new image whose construction can be automated by adding the bundles to the base image.

The building block searching module 111 produces a solution Iᵢ from a requirement graph by matching individual semantic models of building blocks using typed graph isomorphism with constraint checking, the basis of the realization concept (discussed above with respect to semantic models). For example, given the semantic models in FIG. 4 and the requirement graph 500 of FIG. 5, the possible solutions are the following: I₁={Img3}, I₂={Img1, B1, B2, B4}, and I₃={Img2, B1, B2, B4}. Note that bundle B2 satisfies the requirement on WMB, but introduces a requirement on WMQ. This is why bundle B4, which satisfies the requirement on WMQ, is part of solutions I₂ and I₃.

The building block searching module 111, in one embodiment, can cope with two inter-related challenges in the face of a possibly large repository of images and bundles. First, since there could be many possible solutions to a certain search, as the example illustrates, the problem of ranking them becomes evident. Second, to overcome the combinatorial explosion, it would be advantageous to find the most important solutions early in the search process. This obviates the need for traversing a large search space in its entirety.

Given the above, the building block searching module 111, in one embodiment, takes into account a metric (or combination of metrics) that translates into the relative importance the user would assign to solutions. Depending on the goals and needs of the user, different metrics may apply. Examples of quantities that could be part of ranking metrics include: number of building blocks, number of software products, licensing costs, expected completion time (image build plus instantiation times), and rating of building blocks.

Therefore, in different embodiments, the building block searching module 111 utilizes different searching methods for finding the set (or sets) of building blocks that best fulfill the user needs. In one embodiment, the method is greedily guided search. In another embodiment, the method is an integer programming approach. Other embodiments utilize binary programming searching methods, linear programming searching methods, and any combination of searching methods as well. With respect to the greedily guided search, the naive approach of traversing the entire search space looking for solutions and then sorting them based on a ranking metric is not tractable, as discussed above. Rather, one embodiment provides an algorithm that can find high-ranking sets of building blocks while minimizing the search space traversal. This search is greedily guided by a score function and utilizes a user-supplied ranking metric that guides the search towards the best solutions (from the user's perspective) first.

In one embodiment, the inputs to this first searching method are (1) a requirement graph g₀; (2) a set B of building blocks {b₁, b₂, . . . , bₙ}; (3) a score function score(b, g), where bεB, g is a requirement graph, and score(b, g) assigns a score b^{s} to b based on the metrics defined by the user; and (4) the maximum number of solutions to be found, denoted by max.

In addition, the following four operations are defined (1) semantic(b), (2) satisfied (g), (3) apply (g, s), and (4) candidates (g, B). The operation semantic(b) takes a building block b as input and returns its semantic model. The Boolean-valued function satisfied (g) returns true if the requirement graph g has no requirements left to be satisfied (i.e., no unrealized conceptual units), or returns false otherwise. The operation apply(g, s) takes a requirement graph g and a building block's semantic model s to produce a new requirement graph g′ that is the result of realizing the pattern represented by the conceptual units of g with the model represented by s. If s includes additional requirements (conceptual units), they are realized with any concrete units already in g when possible; unsatisfied requirements in s are added to g′. If the input requirement graph g has a conceptual operating system unit (which means that no image has been applied to it) and s is the semantic model of a software bundle, the operation deals with two conceptual operating system units such that either one can be a subtype of the other. In this case, the operation ensures that the realization involving these units is performed in the right direction.

The operation candidates(g, B) is a building block filtering function that takes a requirement graph g and a set of building blocks B and produces a set C⊂B of building blocks such that (1) ∀bεC, b is compatible with g, and (2) ∀bεC, semantic(b) realizes at least one requirement (i.e., conceptual unit) in g with a concrete unit. The second condition guarantees that each candidate building block b reduces the number of requirements present in the input requirement graph g.

A building block b is said to be compatible with a requirement graph g if (1) the operating system unit of g is realizable by the operating system unit of semantic(b) (or vice-versa), (2) apply (g, semantic(b)) does not violate any anti-collocation constraints present in g, and (3) all concrete softwareinstall units (considering attribute values) of semantic(b) are not already present in g. This definition of compatibility guarantees that all software bundles of a solution are compatible with one another and with the operating system of the solution's base image. Moreover, it ensures that a solution contains only unique software products.

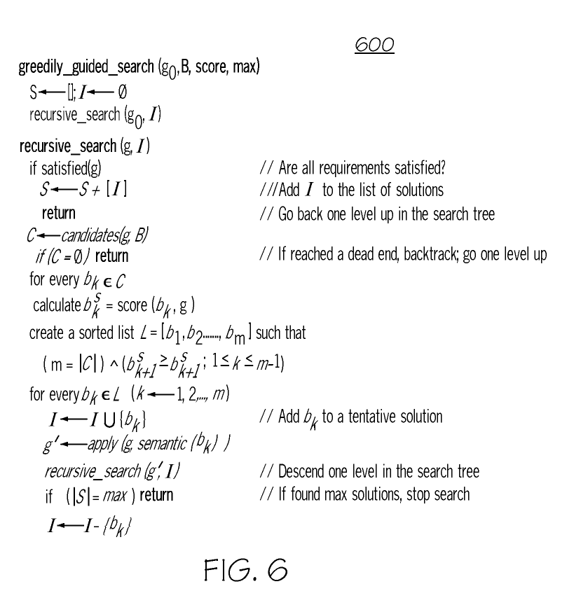

Based on the definitions above, a greedily guided search algorithm 600 is provided as shown in FIG. 6 that is performed by the building block searching module 111. The algorithm 600 returns a list S of solutions that satisfy the requirement graph g₀. Recall that each solution is denoted by a set containing one base image and zero or more software bundles. The order in which the solutions appear in the list S is dictated by the score function/metric provided by the user, which determines how the search space is traversed.

At each search step, the algorithm 600 computes all candidate building blocks based on the current state of the requirement graph, sorts them based on the score function/metric, and iterates over the sorted list of candidates, adding the candidates one at a time to a tentative solution. After a candidate is added to a tentative solution, the state of the requirement graph is updated and the same steps are recursively performed on the updated requirement graph. In other words, the algorithm 600 greedily chooses the next step of the search according to the score function/metric, going progressively deeper into the search tree. Upon reaching a leaf, the algorithm 600 either finds a solution or encounters a dead end; in either case, it backtracks and continues until max solutions are found. For example, in backtracking a method replaces at least one candidate virtual image building block in a set of candidate virtual image building blocks with a new candidate virtual image building block having a next highest score.

The algorithm 600 shown in FIG. 6 provides for, among other things, correctness and convergence. With respect to correctness, if the requirement graph has an operating system requirement, such as the one shown in FIG. 5, the algorithm 600 shown in FIG. 6 guarantees that each solution will have exactly one base image. This is a corollary of the design of semantic models of images and bundles. Recall that an image's semantic model has a concrete operating system unit, whereas a bundle's has a conceptual one. Therefore, an operating system requirement can only be satisfied by an image, i.e., no solution including only software bundles can possibly exist in that situation.

With respect to convergence, since the candidates filtering operation only considers building blocks that satisfy at least one requirement of the input graph, it ensures that some progress is made towards a solution at each search step, thereby limiting the number of levels of the search tree. In fact, if the candidates operation is further restricted to consider only building blocks that satisfy more requirements than they add, the height of the search tree would be bound by the number of units in g₀. However, in one embodiment, this extra restriction is unnecessary.

In the greedily guided search embodiment, a score function captures the aspects of a solution that are important to the user. The greedily guided search algorithm traverses the search space based on the values assigned by the function to the building blocks at each search step so that the most relevant solutions are found first. This approach is useful when a single score function can express all facets in which the user is interested.

One example of a score function score(b, g) that captures a “best fit” type of metric is described next. This function guides the search towards solutions that satisfy the user requirements with as few software products as possible so as to minimize the number of components that are part of the image. Given a candidate building block b and the “current” requirement graph g, this score function assigns a score b^{s} to b as follows: b^{s}=reqSat(b, g)−reqAdded(b, g)−swAdded(b, g). The functions reqSat, reqAdded, and swAdded compute, respectively, the number of satisfied requirements, added requirements, and added software that results from selecting b to a tentative solution. By choosing a candidate with the greatest value of b^{s}, the search first tries building blocks that make the most net contributions towards satisfying the outstanding requirements, thereby giving preference to solutions that minimize the number of software components.

Although sometimes a single score function can weigh multiple metrics of interest in a meaningful way, it cannot easily (if at all) express tradeoffs among multiple (possibly unrelated) metrics. For example, a user may want a solution that minimizes licensing costs while keeping the image construction (process of adding bundles to the base image and capturing it) and instantiation times within a certain limit. In light of this type of scenario, one embodiment models the search as a binary integer programming problem. Integer programming problems are special cases of linear programming problems, which are defined as follows. Given a linear objective function of some decision variables, the problem is to assign values to the decision variables such that the objective function is maximized (or minimized) subject to a number of feasibility constraints that are linear inequalities and/or equalities. The objective function and feasibility constraints are linear functions of the decision variables. In the case of binary integer programming, all decision variables are integers in the domain {0, 1}. This formulation lends itself to model search scenarios of the type exemplified above.

Therefore, one embodiment formulates the problem of searching for an image design as binary integer programming. The inputs to the problem are: (1) a requirement graph R denoting the software and operating system characteristics the user wants (see FIG. 5); (2) a set B of building blocks {b₁, b₂, . . . , bₙ} available in the repository 116, 118; (3) an objective function o capturing metric(s) (related to the image) that the user wants to maximize or minimize; and (4) a list F of constraints representing user restrictions on certain metrics associated with the image. Each building block bᵢεB must be compatible with the requirement graph R (see definition of the candidates operation above). Moreover, for each softwareinstall unit qⱼεsemantic(bᵢ), if qⱼ's type is the same as that of a unit wₖεR, then one of the following conditions must be true: qⱼ realizes wₖ (or vice-versa); or both are identical (same type and attribute values). The output is a set I⊂B of building blocks. If the search is satisfiable, I includes exactly one base image and zero or more software bundles; otherwise, I=Ø.

There are n binary decision variables, one per building block in B. Let m be the number of software bundles and k be the number of base images, such that n=m+k. The decision variables can be represented by a vector \vec{X}=[x₁, x₂, . . . , xₘ, xₘ₊₁, xₘ₊₂, . . . , xₘ₊ₖ] where x₁-xₘ represent bundles and xₘ₊₁-xₘ₊ₖ represent base images. A solution to the binary integer programming problem corresponds to an assignment of values to each decision variable. If xᵢ=1, then bᵢεI; if xᵢ=0, then bᵢ∉I.

In order to guarantee solution correctness, the assignment of values to the vector X made by the integer programming solver, in one embodiment, needs to correspond to a set I that includes exactly one base image. This can be accomplished by introducing the following feasibility constraint: xₘ₊₁+xₘ₊₂+ . . . +xₘ₊ₖ=1, which can be referred to as “single-image constraint”. Furthermore, to ensure that every requirement (conceptual unit) in R and those added by selected building blocks are satisfied (realized by a concrete unit) in the solution, a set of coverage constraints is introduced. The set of coverage constraints is formulated in terms of coverage vectors as follows. Let U be the set of all units (vertices) of R and of semantic(bᵢ), ∀bᵢεB, combined. For example, in FIG. 4, U includes 18 units. Let O⊂U be the set of operatingsystem units. The set of unique unit classes, U, can be defined as a set of equivalency classes of U−O where for u,vε(U−O), u≡v if: (a) u realizes v; or (b) v realizes u; or (c) the type of u (Lᵤ) is a non-strict super-type of the type of v (Lᵥ) and for every attribute aεattributes(Lᵤ),value(u,a)=value(v,a); or (d) the type Lᵥ is a non-strict supertype of Lᵤ and for every attribute a E attributes(Lᵥ),value(v,a)=value(u,a).

Based on this definition, the set U for FIG. 4 includes 3 elements corresponding to the unique unit classes DB2 ESE (9.7.1), WMB (7.0.0.2), and WMQ (7.0.0.4). Finally, let \vec{U}=[u₁, u₂, . . . , uₚ] be a vector created from U that assigns an (arbitrary, but fixed) order to the elements of U.

The coverage vector for R can be defined as \vec{C^{R}}=[c₁^{R}, c₂^{R}, . . . , cₚ^{R}] and coverage vectors for each building block bᵢεB as \vec{Cⁱ}=[c₁ⁱ, c₂ⁱ, . . . , cₚⁱ] where

$${c}_{j}^{R} = \{ \begin{matrix}0 & if R does not contain a unit of the {u}_{j} class \\ \vert B \vert & if R contains a concrete unit of the {u}_{j} class \\ - 1 & if R contains a coneptual unit of the {u}_{j} class\end{matrix}$$

The values for cⱼⁱ, for each vector \vec{Cⁱ}, can be similarly defined.

For example, consider the models in FIG. 4. As above, \vec{U}=[DB2 ESE (9.7.1), WMB (7.0.0.2), WMQ (7.0.0.4)]. The coverage vector for the requirement graph is \vec{C^{R}}=[−1, −1, 0], while bundle B2 has its coverage vector \vec{C^{B2}}=[0, 7, −1].

Coverage vectors are used to define feasibility constraints whose aim is to ensure that the integer programming solver assigns values to \vec{X} corresponding to a set of building blocks that leave no requirement unsatisfied. For each uⱼεU (1≦j≦p), the following feasibility constraint is defined: (Σᵢ₌₁ⁿxᵢcⱼⁱ)+cⱼ^{R}≧0. The rationale behind these constraints is the following. Based on the definition of coverage vectors, each requirement for a unit class uⱼ corresponds to −1, whereas each time uⱼ is provided corresponds to |B|. By enforcing the summation above to be no less than 0, a guarantee is provided that if there exists a requirement for uⱼ, a valid solution needs to have a building block xᵢ that provides uⱼ. That condition holds true even for a solution where n−1 (|B|−1) building blocks require uⱼ and one building block provides it.

To ensure the solution contains unique software products, another set of feasibility constraints is defined. To that end, a software vector \vec{S^{R}} is defined, associated with R, and n software vectors \vec{Sⁱ}(1≦i≦n), associated with each bᵢεB. Values are assigned to each element sⱼ of a software vector as follows: if uⱼ appears in the model as a concrete unit, sⱼ=1; otherwise, sⱼ=0. The following constraint is then dictated for each uⱼεU (1≦j≦p): (Σᵢ₌₁ⁿxᵢsⱼⁱ)+sⱼ^{R}≦1.

In another embodiment, a guarantee is provided that the solution does not include incompatible software. In the graph models of one or more embodiments, software incompatibility is represented by anti-collocation links. In the integer programming formulation anti-collocation links are translated into the anti-collocation vectors \vec{A^{R}} and \vec{Aⁱ} (1≦i≦n). If an incompatibility with a class uⱼ is indicated in the model, aⱼ=1; otherwise, aⱼ=0. Then, the following anti-collocation constraint is defined for each uⱼεU (1≦j≦p) and each b_{z}εB (1≦z≦n): (Σᵢ₌₁ⁿxᵢsⱼⁱ)_{i≈z}+aⱼ^{z}+sⱼ^{R}≦1.

OS incompatibility constraints are also defined. Consider the example of FIGS. 4-5. Clearly, bundles B2 and B3 cannot be part of the same solution, since they require different distributions of Linux: the former requires RHEL, whereas the latter, SLES. In the integer programming model, this is captured in anti-collocation vectors similar to the ones defined above, and analogous feasibility constraints are relied on.

All constraints above are added automatically by processing the graph models in order to ensure solution correctness. Another set F of constraints can be provided as input by the user so that certain desired characteristics are enforced. Without loss of generality, suppose that the following quantities are associated with each building block bᵢεB: licensing cost and completion time. For a bundle, completion time would be the time it takes for it to be installed; for an image, the time it takes for it to be instantiated. Values for those quantities are represented as the vectors \vec{L} and \vec{T}, respectively. Then, the user could determine that a valid solution must have the total licensing cost bound by cost. A constraint for expressing that can be: Σᵢ₌₁ⁿxᵢlᵢ≦cost. Finally, the user can specify that she wants a solution whose completion time is minimum. That would be expressed as MIN(Σᵢ₌₁ⁿxᵢtᵢ). This objective function and all constraints can then be given to an integer programming solver (either within the building block searching module 11 or separate therefrom), which produces a solution minimizing the objective function subject to all constraints.

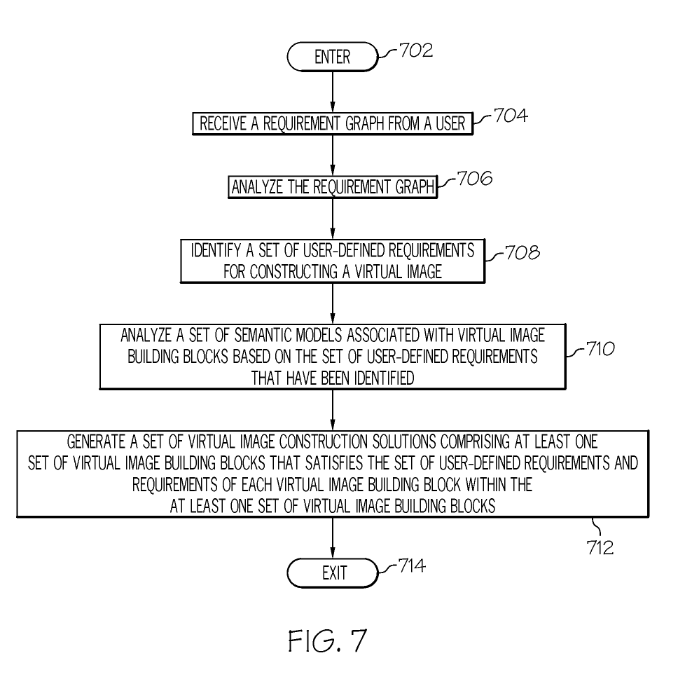

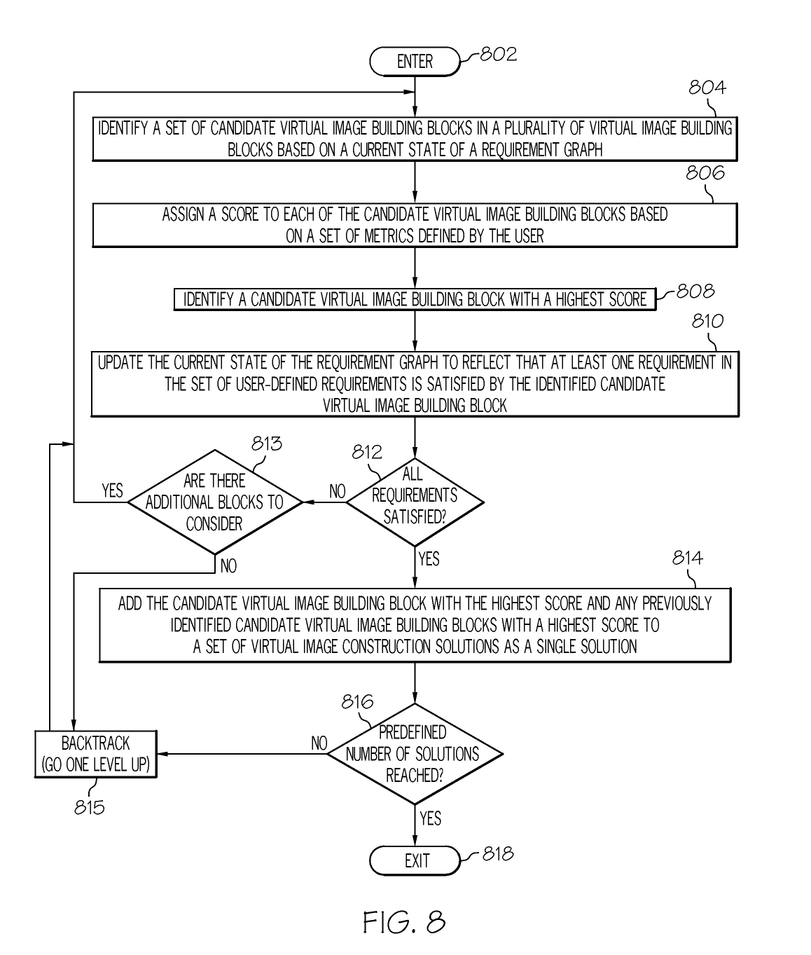

FIG. 7 shows an overall operational flow diagram for a search operation that identifies virtual image building blocks for constructing a virtual image. It should be noted that the steps of the operation flow diagram shown in FIG. 7 have already been discussed above in greater detail. The operational flow diagram of FIG. 7 begins at step 702 and flows directly to step 704. The building block searching module 111, at step 704, receives a requirement graph 500 from a user. The building block searching module 111, at step 706, analyzes the requirement graph 500. The building block searching module 111, at step 708 identifies a set of user-defined requirements from the requirement graph 500 for constructing a virtual image.

The building block searching module 111, at step 710, analyzes a set of semantic models associated with virtual image building blocks based on the set of user-defined requirements that have been identified. The building block searching module 111, at step 712, generates, based on the analyzing, a set of virtual image construction solutions. Each virtual image construction solution comprises at least one set of virtual image building blocks from the plurality of virtual image building blocks. The at least one set of virtual image building blocks satisfies the set of user-defined requirements and requirements of each virtual image building block within the at least one set of virtual image building blocks. It should be noted that the set of virtual image construction solutions can be presented to the user via one or more interfaces 112, 114. Alternatively, the set of virtual image construction solutions can be supplied to a virtual image construction tool 109 as an input for constructing a virtual image based thereon. This constructed virtual image can then be presented to the user via one or more user interfaces 112, 114. The control flow then exits at step 714.

FIG. 8 shows an operational flow diagram for a greedy-based search operation that identifies virtual image building blocks for constructing a virtual image. It should be noted that the steps of the operation flow diagram shown in FIG. 8 have already been discussed above in greater detail. The operational flow diagram of FIG. 8 begins at step 802 and flows directly to step 804. The building block searching module 111, at step 804, identifies a set of candidate virtual image building blocks in a plurality of virtual image building blocks based on a current state of a requirement graph received from a user. The building block searching module 111, at step 806, assigns a score to each of the candidate virtual image building blocks based on a set of metrics defined by the user.

The building block searching module 111, at step 808, identifies a candidate virtual image building block with a highest score. The building block searching module 111, at step 810, updates the current state of the requirement graph to reflect that at least one requirement in the set of user-defined requirements is satisfied by the identified candidate virtual image building block. The building block searching module 111, at step 812, determines if all the user-defined requirements and requirements of the identified candidate virtual image building block(s) have been satisfied. If the result of this determination is negative, the building block searching module 111 determines, at step 813, there are any additional building blocks that can be applied. If so, the control flow returns to step 804 where the searching process is repeated. If this determination is negative, the current state of the solution, at step 815, is undone via backtracking. The control flow returns to step 804 where the searching process is repeated.

If the result of the determination at step 812 is positive, the building block searching module 111, at step 814, adds the candidate virtual image building block with the highest score (and any identified candidate virtual image building blocks with a highest score from previous iterations) to a set of virtual image construction solutions as a single solution. The building block searching module 111, at step 816, then determines if a predefined number of solutions have been reached. If the result of this determination is negative, the control flow returns to step 804 where the searching process is repeated. If the result of this determination is positive, the control flow then exits at step 818.

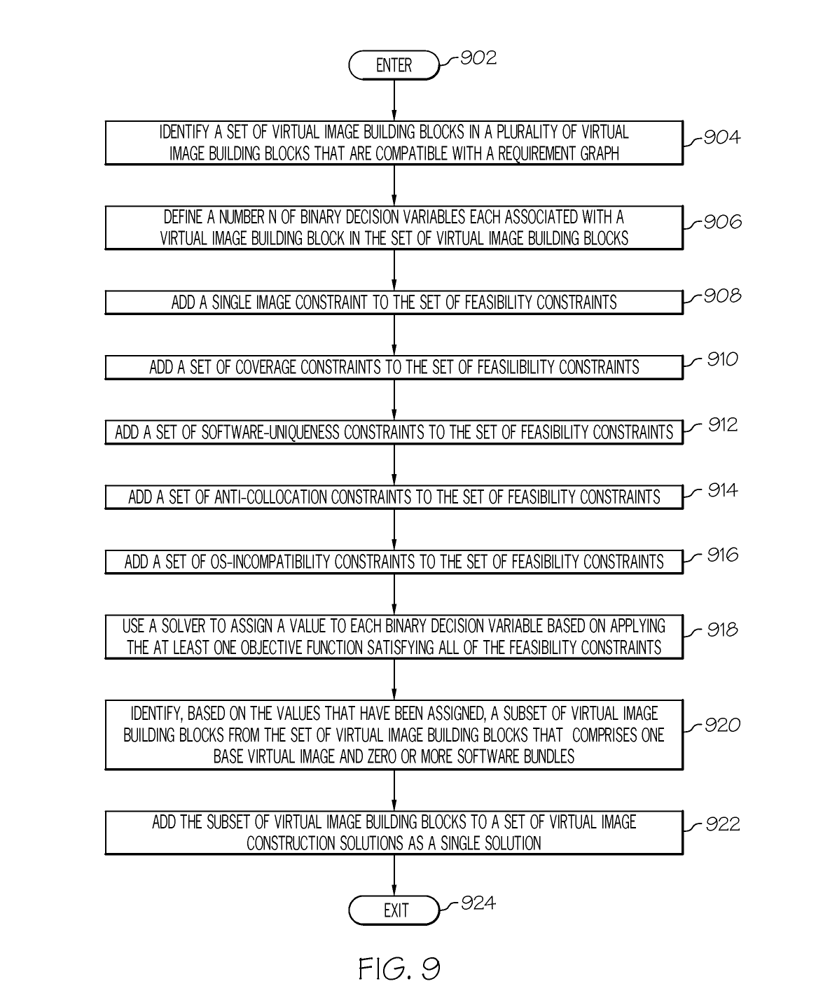

FIG. 9 shows an example of an operational flow diagram which in this example utilizes a binary integer programming based search operation that identifies virtual image building blocks for constructing a virtual image. It should be noted that the steps of the operation flow diagram shown in FIG. 9 have already been discussed above in greater detail. The operational flow diagram of FIG. 9 begins at step 902 and flows directly to step 904. The building block searching module 111, at step 904, identifies a set of virtual image building blocks in a plurality of virtual image building blocks that are compatible with a requirement graph received from a user. The building block searching module 111, at step 906, defines a number of n binary decision variables each being associated with a virtual image building block in the set of virtual image building blocks.

The building block searching module 111 then adds feasibility constraints to restrict the solution to a valid solution as follows. A single image constraint, at step 908, is added to the set of feasibility constraints to ensure that any solution contains a single virtual image building block. A set of coverage constraints, at step 910, are added to the set of feasibility constraints to ensure that any solution contains building blocks that satisfy all of the requirements in the requirement graph and any requirements added by any building block. A set of software uniqueness constraints, at step 912, are added to the feasibility constraints to ensure that any solution contains a combination of building blocks that do not contain the same software product. A set of anti-collocation constraints, at step 914, are added to the set of feasibility constraints to ensure that any solution contains building blocks with valid combinations of software products. A set of OS compatibility constraints, at step 918, are added to the set of feasibility constraints to ensure that any solution contains building blocks that are compatible with respect to their operating systems.

The building block searching module 111, at step 918, in one embodiment, uses a solver to assign a value to each binary decision variable based on applying the at least one of the objective function and satisfying the set of feasibility constraints. The building block searching module 111 assigns a value to each binary decision variable based on applying the at least one of the objective function and the set of constraints to the set of virtual image building blocks. The building block searching module 111, at step 920, identifies, based on the values that have been assigned, a subset of virtual image building blocks from the set of virtual image building blocks that comprises one base virtual image and zero or more software bundles. The building block searching module 111, at step 922, adds a subset of virtual image building blocks to the set of virtual image construction solutions as a single solution. The control flow then exits at step 924.

Cloud Environment

It is understood in advance that although the following is a detailed discussion on cloud computing, implementation of the teachings recited herein are not limited to a cloud computing environment. Rather, various embodiments of the present invention are capable of being implemented in conjunction with any other type of computing environment now known or later developed. For example, various embodiments of the present invention are applicable to any computing environment with a virtualized infrastructure or any other type of computing environment.

For convenience, the Detailed Description includes the following definitions which have been derived from the “Draft NIST Working Definition of Cloud Computing” by Peter Mell and Tim Grance, dated Oct. 7, 2009, which is cited in an IDS filed herewith, and a copy of which is attached thereto. However, it should be noted that cloud computing environments that are applicable to one or more embodiments of the present invention are not required to correspond to the following definitions and characteristics given below or in the “Draft NIST Working Definition of Cloud Computing” publication. It should also be noted that the following definitions, characteristics, and discussions of cloud computing are given as non-limiting examples.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or by a third party, and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

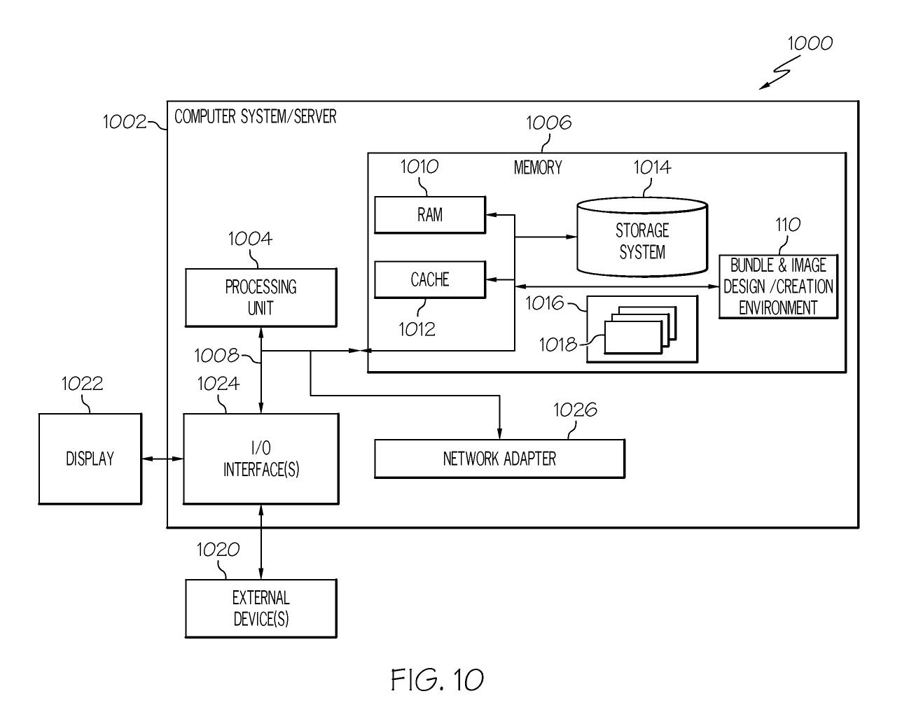

Referring now to FIG. 10, a schematic of an example of a cloud computing node is shown. Cloud computing node 1000 is only one example of a suitable cloud computing node and is not intended to suggest any limitation as to the scope of use or functionality of embodiments of the invention described herein. Regardless, cloud computing node 1000 is capable of being implemented and/or performing any of the functionality set forth hereinabove.

In cloud computing node 1000 there is a computer system/server 1002, which is operational with numerous other general purpose or special purpose computing system environments or configurations. Examples of well-known computing systems, environments, and/or configurations that may be suitable for use with computer system/server 1002 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1002 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1002 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1002 in cloud computing node 1000 is shown in the form of a general-purpose computing device. The components of computer system/server 1002 may include, but are not limited to, one or more processors or processing units 1004, a system memory 1006, and a bus 1008 that couples various system components including system memory 1006 to processor 1004.

Bus 1008 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1002 typically includes a variety of computer system readable media. Such media may be any available media that is accessible by computer system/server 1002, and it includes both volatile and non-volatile media, removable and non-removable media.

System memory 1006, in one embodiment, comprises the interactive environment 110 and its components as shown in FIG. 1. These one or more components of the interactive environment 110 can also be implemented in hardware as well. The system memory 1006 can include computer system readable media in the form of volatile memory, such as random access memory (RAM) 1010 and/or cache memory 1012. Computer system/server 1002 may further include other removable/non-removable, volatile/non-volatile computer system storage media. By way of example only, storage system 1014 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1008 by one or more data media interfaces. As will be further depicted and described below, memory 1006 may include at least one program product having a set (e.g., at least one) of program modules that are configured to carry out the functions of various embodiments of the invention.

Program/utility 1016, having a set (at least one) of program modules 1018, may be stored in memory 1006 by way of example, and not limitation, as well as an operating system, one or more application programs, other program modules, and program data. Each of the operating system, one or more application programs, other program modules, and program data or some combination thereof, may include an implementation of a networking environment. Program modules 1018 generally carry out the functions and/or methodologies of various embodiments of the invention as described herein.

Computer system/server 1002 may also communicate with one or more external devices 1020 such as a keyboard, a pointing device, a display 1022, etc.; one or more devices that enable a user to interact with computer system/server 1002; and/or any devices (e.g., network card, modem, etc.) that enable computer system/server 1002 to communicate with one or more other computing devices. Such communication can occur via I/O interfaces 1024. Still yet, computer system/server 1002 can communicate with one or more networks such as a local area network (LAN), a general wide area network (WAN), and/or a public network (e.g., the Internet) via network adapter 1026. As depicted, network adapter 1026 communicates with the other components of computer system/server 1002 via bus 1008. It should be understood that although not shown, other hardware and/or software components could be used in conjunction with computer system/server 1002. Examples, include, but are not limited to: microcode, device drivers, redundant processing units, external disk drive arrays, RAID systems, tape drives, and data archival storage systems, etc.

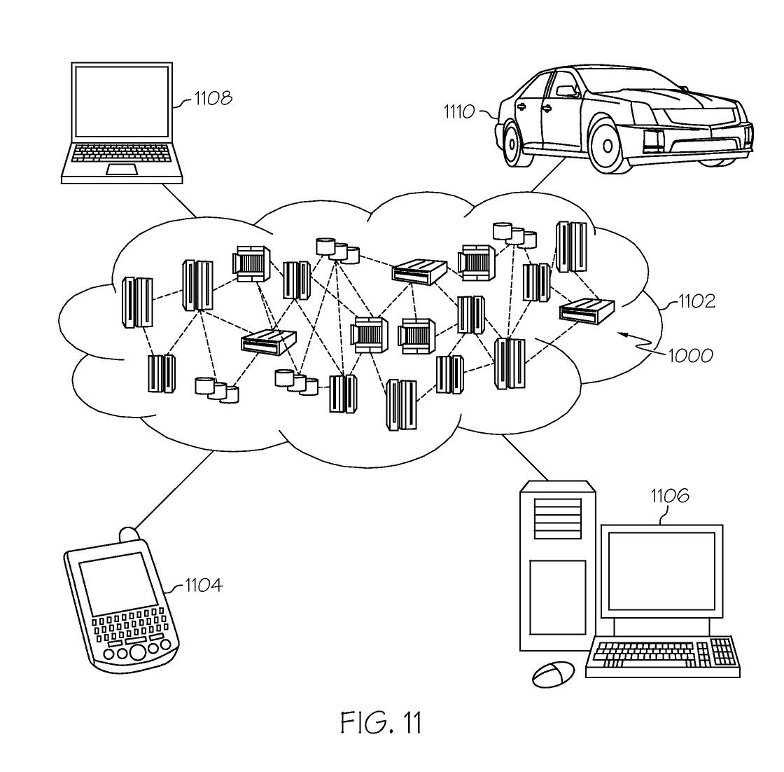

Referring now to FIG. 11, illustrative cloud computing environment 1102 is depicted. As shown, cloud computing environment 1102 comprises one or more cloud computing nodes 1000 with which local computing devices used by cloud consumers, such as, for example, personal digital assistant (PDA) or cellular telephone 1104A, desktop computer 1106B, laptop computer 1108, and/or automobile computer system 1110 may communicate. Nodes 1000 may communicate with one another. They may be grouped (not shown) physically or virtually, in one or more networks, such as Private, Community, Public, or Hybrid clouds as described hereinabove, or a combination thereof. This allows cloud computing environment 1102 to offer infrastructure, platforms and/or software as services for which a cloud consumer does not need to maintain resources on a local computing device. It is understood that the types of computing devices 1104, 1106, 1108, 1110 shown in FIG. 11 are intended to be illustrative only and that computing nodes 1000 and cloud computing environment 1102 can communicate with any type of computerized device over any type of network and/or network addressable connection (e.g., using a web browser).

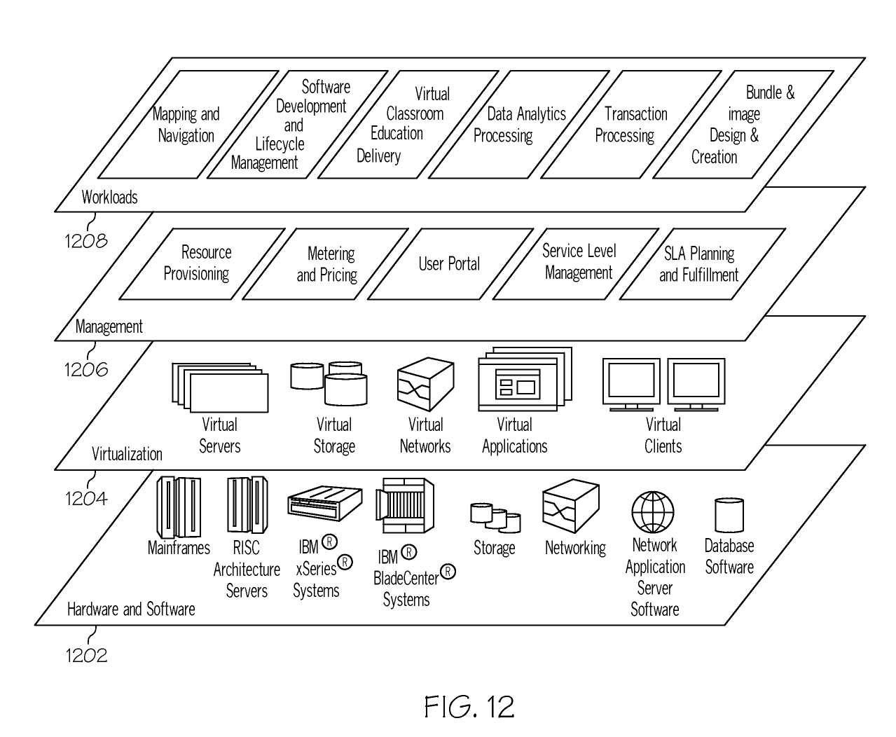

Referring now to FIG. 12, a set of functional abstraction layers provided by cloud computing environment 1102 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1202 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide)

Virtualization layer 1204 provides an abstraction layer from which the following examples of virtual entities may be provided: virtual servers; virtual storage; virtual networks, including virtual private networks; virtual applications and operating systems; and virtual clients.

In one example, management layer 1206 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1208 provides examples of functionality for which the cloud computing environment may be utilized. Examples of workloads and functions which may be provided from this layer include: mapping and navigation; software development and lifecycle management; virtual classroom education delivery; data analytics processing; transaction processing; and composable software bundle and virtual image asset design and creation.

### Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for identifying building blocks for creating a virtual image, the method comprising:
analyzing a requirement graph defined by a user;
identifying, based on the analyzing, a set of user-defined requirements for constructing a virtual image;
analyzing, based on the set of user-defined requirements, a set of models that have been identified, wherein each model in the set of models represents at least one capability and one requirement of a virtual image building block in a plurality of virtual image building blocks; and
generating, based on the analyzing, a set of virtual image construction solutions, wherein each virtual image construction solution comprises at least one set of virtual image building blocks from the plurality of virtual image building blocks, and wherein the at least one set of virtual image building blocks satisfies the set of user-defined requirements and requirements of each virtual image building block within the at least one set of virtual image building blocks.

2. The method of claim 1, wherein the plurality of virtual image building blocks comprises at least one base virtual image and zero or more software bundles.

3. The method of claim 1, wherein at least one of the generated virtual image construction solutions in the set of virtual image construction solutions comprises one base virtual image and zero or more software bundles.

4. The method of claim 1, further comprising:
presenting the set of virtual image construction solutions to the user via a user interface.

5. The method of claim 1, wherein generating the set of virtual image construction solutions comprises:
performing a greedily guided search operation comprising:
identifying a set of candidate virtual image building blocks in the plurality of virtual image building blocks based on a current state of the requirement graph, wherein each candidate virtual image building block is compatible with the current state of the requirement graph, and wherein at least one capability of each candidate virtual image building block satisfies at least one requirement of the current state of the requirement graph; and
assigning a score to each of the candidate virtual image building blocks based on a set of metrics defined by the user.

6. The method of claim 5, wherein the set of metrics comprises at least one of:
a number of virtual image building blocks;
a number of software products;
licensing costs;
an expected completion time for building and instantiating a virtual image; and
a set of ratings for virtual image building blocks.

7. The method of claim 5, wherein performing the greedily guided search operation further comprises:
iteratively:
identifying a candidate virtual image building block in the plurality of virtual image building blocks with a highest score based on a current state of the requirement graph; and
updating the current state of the requirement graph to reflect that at least one requirement in the set of user-defined requirements is satisfied by the candidate virtual image building block that has been identified.

8. The method of claim 7, wherein performing the greedily guided search operation further comprises:
backtracking when no candidate virtual image building blocks in the set of candidate virtual image building blocks are compatible with the current state of the requirement graph, wherein backtracking comprises replacing at least one candidate virtual image building block in the set of candidate virtual image building blocks with a new candidate virtual image building block having a next highest score.

9. The method of claim 7, wherein performing the greedily guided search operation further comprises:
performing the greedily guided search operation using the updated current state of the requirement graph until the set of virtual image construction solutions comprises a predefined number of solutions.

10. The method of claim 1, wherein generating the set of virtual image construction solutions comprises:
performing an integer programming based search operation comprising:
identifying a set of virtual image building blocks in the plurality of virtual image building blocks that are compatible with the requirement graph;
defining a number of decision variables each associated with a virtual image building block in the set of virtual image building blocks;
assigning a value to each decision variable indicating whether the associated virtual image building block is to be included in a virtual image construction solution in the set of virtual image construction solutions;
identifying a subset of virtual image building blocks from the set of virtual image building blocks that are compatible with the requirement graph based on the decision variables and assigned values; and
adding the subset of virtual image building blocks to the set of virtual image construction solutions as a single virtual image construction solution.

11. The method of claim 10, wherein assigning the value to each decision variable optimizes a user defined objective function.

12. The method of claim 10, wherein a value is assigned to each decision variable based on at least one of:
a requirement that the single virtual image construction solution comprises only one base image;
a requirement that software in one virtual image building block in the subset of virtual image building blocks does not include the same software that is in another virtual image building block in the subset of virtual image building blocks;
a requirement that virtual image building blocks in the subset of virtual image building blocks comprise software that is compatible to software of other virtual image building blocks in the subset of virtual image building blocks;
a requirement that virtual image building blocks in the subset of virtual image building blocks comprise software that can be collocated without conflict;
a requirement that virtual image building blocks in the subset of virtual image building blocks comprise one base image and a set of bundles that are compatible with the one base image; and
a requirement that single virtual image construction solution satisfies user provided constraints.

13. A system for identifying building blocks for creating a virtual image, the information processing system comprising:
a memory;
a processor communicatively coupled to the memory; and
a building block searching module communicatively coupled to the memory and the processor, the building block searching module being configured to perform a method comprising:
analyzing a requirement graph defined by a user;
identifying, based on the analyzing, a set of user-defined requirements for constructing a virtual image;
analyzing, based on the set of user-defined requirements, a set of models that have been identified, wherein each model in the set of models represents at least one capability and one requirement of a virtual image building block in a plurality of virtual image building blocks; and
generating, based on the analyzing, a set of virtual image construction solutions, wherein each virtual image construction solution comprises at least one set of virtual image building blocks from the plurality of virtual image building blocks, and wherein the at least one set of virtual image building blocks satisfies the set of user-defined requirements and requirements of each virtual image building block within the at least one set of virtual image building blocks.

14. The system of claim 13, wherein generating the set of virtual image construction solutions comprises:
performing a greedily guided search operation comprising:
identifying a set of candidate virtual image building blocks in the plurality of virtual image building blocks based on a current state of the requirement graph, wherein each candidate virtual image building block is compatible with the current state of the requirement graph, and wherein at least one capability of each candidate virtual image building block satisfies at least one requirement of the current state of the requirement graph; and
assigning a score to each of the candidate virtual image building blocks based on a set of metrics defined by the user.

15. The system of claim 14, wherein performing the greedily guided search operation further comprises:
iteratively:
identifying a candidate virtual image building block in the plurality of virtual image building blocks with a highest score based on a current state of the requirement graph; and
updating the current state of the requirement graph to reflect that at least one requirement in the set of user-defined requirements is satisfied by the candidate virtual image building block that has been identified.

16. The system of claim 15, wherein performing the greedily guided search operation further comprises:
backtracking when no candidate virtual image building blocks in the set of candidate virtual image building blocks are compatible with the current state of the requirement graph, wherein backtracking comprises replacing at least one candidate virtual image building block in the set of candidate virtual image building blocks with a new candidate virtual image building block having a next highest score.

17. The system of claim 15, wherein performing the greedily guided search operation further comprises:
performing the greedily guided search operation using the updated current state of the requirement graph until the set of virtual image construction solutions comprises a predefined number of solutions.

18. The system of claim 14, wherein generating the set of virtual image construction solutions comprises:
performing an integer programming based search operation comprising:
identifying a set of virtual image building blocks in the plurality of virtual image building blocks that are compatible with the requirement graph;
defining a number of decision variables each associated with a virtual image building block in the set of virtual image building blocks;
assigning a value to each decision variable indicating whether the associated virtual image building block is to be included in a virtual image construction solution in the set of virtual image construction solutions;
identifying a subset of virtual image building blocks from the set of virtual image building blocks that are compatible with the requirement graph based on the decision variables and assigned values; and
adding the subset of virtual image building blocks to the set of virtual image construction solutions as a single virtual image construction solution.

19. A computer program product for identifying building blocks for creating a virtual image, the in computer program product comprising:
a storage medium readable by a processing circuit and storing instructions for execution by the processing circuit for performing a method comprising:
analyzing a requirement graph defined by a user;
identifying, based on the analyzing, a set of user-defined requirements for constructing a virtual image;
analyzing, based on the set of user-defined requirements, a set of models that have been identified, wherein each model in the set of models represents at least one capability and one requirement of a virtual image building block in a plurality of virtual image building blocks; and
generating, based on the analyzing, a set of virtual image construction solutions, wherein each virtual image construction solution comprises at least one set of virtual image building blocks from the plurality of virtual image building blocks, and wherein the at least one set of virtual image building blocks satisfies the set of user-defined requirements and requirements of each virtual image building block within the at least one set of virtual image building blocks.

20. The computer program product of claim 19, wherein generating the set of virtual image construction solutions comprises:
performing a greedily guided search operation comprising:
identifying a set of candidate virtual image building blocks in the plurality of virtual image building blocks based on a current state of the requirement graph, wherein each candidate virtual image building block is compatible with the current state of the requirement graph, and wherein at least one capability of each candidate virtual image building block satisfies at least one requirement of the current state of the requirement graph; and
assigning a score to each of the candidate virtual image building blocks based on a set of metrics defined by the user.

21. The computer program product of claim 20, wherein performing the greedily guided search operation further comprises:
iteratively:
identifying a candidate virtual image building block in the plurality of virtual image building blocks with a highest score based on a current state of the requirement graph; and
updating the current state of the requirement graph to reflect that at least one requirement in the set of user-defined requirements is satisfied by the candidate virtual image building block that has been identified.

22. The computer program product of claim 21, wherein performing the greedily guided search operation further comprises:
backtracking when no candidate virtual image building blocks in the set of candidate virtual image building blocks are compatible with the current state of the requirement graph, wherein backtracking comprises replacing at least one candidate virtual image building block in the set of candidate virtual image building blocks with a new candidate virtual image building block having a next highest score.

23. The computer program product of claim 21, wherein performing the greedily guided search operation further comprises:
performing the greedily guided search operation using the updated current state of the requirement graph until the set of virtual image construction solutions comprises a predefined number of solutions.

24. The computer program product of claim 19, wherein generating the set of virtual image construction solutions comprises:
performing an integer programming based search operation comprising:
identifying a set of virtual image building blocks in the plurality of virtual image building blocks that are compatible with the requirement graph;
defining a number of decision variables each associated with a virtual image building block in the set of virtual image building blocks;
assigning a value to each decision variable indicating whether the associated virtual image building block is to be included in a virtual image construction solution in the set of virtual image construction solutions;
identifying a subset of virtual image building blocks from the set of virtual image building blocks that are compatible with the requirement graph based on the decision variables and assigned values; and
adding the subset of virtual image building blocks to the set of virtual image construction solutions as a single virtual image construction solution.
